(19) United States
(12) Patent Application Publication
(10) Pub. No.: US 2006/0150579 A1
(43) Pub. Date: Jul. 13, 2006

(54) Method for forming a security stopper-capsule and applying it to containers with a threaded mouth, and the stopper-capsule obtained thereby

(75) Inventor: Francesco Piero Macchi, Varese (IT)

Correspondence Address: YOUNG & THOMPSON, 745 SOUTH 23RD STREET, 2ND FLOOR, ARLINGTON, VA, 22202, US

(73) Assignee: Enoplastic S.P.A., Milan (IT)

(21) Appl. No.: 10/533,339

(22) PCT Filed: Oct. 15, 2003
(86) PCT No.: PCT/EP03/11397

§ 371 Date: Mar. 6, 2006

(30) Foreign Application Priority Data
Oct. 31, 2002 (IT) MI2002A002324

(51) Int. Cl. B67B 3/20; B67B 1/03

(52) U.S. Cl. 53/290; 53/317

(57) ABSTRACT

The method enables a closure and security device having a screw stopper and a security capsule to be formed and applied to a container having an externally threaded circular mouth. The method includes: connecting to a stopper, a capsule forming foil as to provide the stopper with a skirt projecting by a determined portion from the free edge of the stopper, to obtain—a-stopper-skirt combination, applying the combination to the mouth of the container; and making the skirt rigid with the container, so as to obtain a stopper-capsule. The closure and security device includes a screw stopper, and a capsule which is rigid both with the screw stopper and with the adjacent part of the outer surface of the container.

The present invention relates to method for forming a closure and security device and applying it to containers provided with an externally threaded circular mouth, in particular containers in the form of bottles, and to a closure and security device itself.

Containers (in particular bottles and jars) having an externally threaded mouth and closed by simple screw stoppers have been available commercially for many years. Containers of this type are widely used for most liquids (in particular water, soft drinks, oil, wine, liqueurs and their derivatives). Traditionally these screw stoppers, in the form of an inverted cup, are of aluminium and present no thread prior to their application. When disposed on the externally threaded mouth of the container, they are rolled to form in their lateral wall a thread which matches that of the container mouth (the stopper becoming in effect a screw stopper only as a result of the rolling operation).

Screw stoppers of a suitable plastic material have also been manufactured, these being produced already threaded by injection moulding and then screwed onto the thread of the container mouth.

To ensure that the container on which these screw stoppers has been applied has not been tampered with, the screw stoppers (whether of aluminium or of synthetic material) are provided at their free edge with a turn-in cooperating with a corresponding annular undercut provided on the outer surface of the container. This turn-in forms a security ring which is connected to the remaining part of the screw stopper by a series of angularly equidistant small teeth to be torn when force is applied to the screw stopper to unscrew it. Breakage of these teeth hence indicates the fact that the container has already been opened, whereas tooth integrity provides the guarantee that the container contents have not been tampered with or altered. In the case of aluminium screw stoppers, said security ring is obtained by the same rolling operation which forms the stopper thread, whereas in the case of plastic screw stoppers it is formed during the injection moulding of the stopper. In this latter case, the ring (because of the elasticity of the material with which it is formed) can pass beyond the relative undercut on the container as the result of final forcing while screwing the stopper onto the relative container mouth.

Although widely used, these screw stoppers with a security ring present however the following drawbacks:

1. It is a common experience that tearing the teeth connecting the ring to the actual screw stopper, by manually unscrewing this latter, is difficult or indeed impossible to achieve by a person of normal force. The result is that the container cannot be opened unless the person is of greater than normal robustness or unless an implement is used.

Again, it can happen that the resistance offered by said teeth against tearing is too low, so that tearing already occurs during the application of the screw stopper, hence its function as a guarantee against tampering of the container is no longer performed.

2. If the stopper is of aluminium, tearing said teeth connecting the ring to the actual screw stopper gives rise to sharp projections which can be dangerous to the extent of injuring the hand of the person unscrewing the stopper. This danger is accentuated if the unscrewing (as indicated in the preceding point 1) should require a force greater than that normally required.

A natural evolution of the screw stopper with security ring is represented by the known closure device comprising a screw stopper provided with a security ring which extends considerably downwards to cover the relative portion of the container, in order to give this latter a particular appearance. A closure device of this type is known for example by the brand name STELVIN, of the French firm Pechiney. This type of closure and security device also presents the drawbacks stated under the preceding points 1 and 2, in addition to being very costly.

In view of the fact that the screw stopper with a security ring is unable to guarantee absolute inviolability of the relative container, it has been thought to achieve this result by a closure device which, although using a screw stopper with ring, essentially entrusts the inviolability guarantee function not only to the screw stopper with ring, which as already seen does not provide an absolute assurance of inviolability, but also to an added conventional capsule. In this respect, a capsule is essentially an element in the form of a hood formed from a foil of suitable metal (for example aluminium or tin) or of a suitable heat-shrinkable plastic material. The starting foil is in the form of a substantially trapezoidal piece from which a tubular element is formed, or is already in the form of a tubular element, and is applied to the mouth of bottles (especially containing wine) which have already been closed by a conventional cork or synthetic stopper, or (as in the aforesaid case) by a screw stopper with ring. The tubular element is also provided with a metal or plastic “headpiece” which closes it upperly to form a hood and is then made to adhere, by rolling or by heating (depending on whether the foil is of metal or of heat-shrinkable plastic material), to the relative portion of the bottle neck.

In all cases an intact capsule is the guarantee that the bottle contents have not been tampered with or replaced.

Returning to the aforesaid known case of a closure device provided with both a screw stopper with ring and a capsule, it is the intactness of this latter (and not of the teeth on the ring of the screw stopper) which provides the guarantee that the container has not been tampered with.

Although this latter solution provides a guarantee against tampering of the container contents, it means that two separate independent operations have to be performed on the automatic container filling and closure line (in the case of bottles, the so-called bottling line), namely the application of the screw stopper with ring to the threaded mouth of the container and the subsequent application of the capsule to this stopper, the capsule then being made rigid by rolling or by heat shrinkage (depending on whether it is of metal or heat-shrinkable plastic material). The need to perform the two aforedescribed operations one after the other evidently results in a considerable lengthening of the bottling time and a non-negligible increase in production costs. It should also be noted that to open a container provided with such a closure and security device, the capsule must firstly be removed. This is difficult, or even impossible, if using the hands alone. Consequently an implement such as a knife has normally to be used.

In this respect, this drawback can be overcome by using a capsule provided with a pull tab, i.e. a strip incorporated into the capsule and having a projecting end which when pulled manually tears the capsule, which can then be easily removed with the hands. The pull tab represents however an additional cost.

An object of the present invention is to provide a method which enables a closure and security device comprising a screw stopper and capsule to be formed and applied to containers with an externally threaded circular mouth, in considerably less time (with significant benefit to production costs) than the aforedescribed known method in which the screw stopper and capsule are applied to the container in two successive steps.

Another object of the invention is to provide a closure and security device of the aforesaid type which does not present the aforedescribed drawbacks of closure devices with a screw stopper provided with a security ring.

The initially stated object is attained by the method of the present invention, comprising the following steps:

connecting to a screw stopper, or to a stopper destined to become a screw stopper once applied to the container, a capsule-forming foil in such a manner as to provide the stopper with a skirt projecting by a determined portion from the free edge of the stopper, to obtain a stopper-skirt combination;

applying the stopper-skirt combination to the mouth of the relative container;

making the skirt rigid with the container by known capsule techniques, depending on the type of foil used, so as to obtain a stopper-capsule.

In this manner the stopper-capsule can be applied to the relative container in a significantly less time than the time required in the known method, which firstly applies the screw stopper and then the capsule.

It should be noted that hereinafter, unless otherwise specified, the term “screw stopper” also indicates a stopper which is not yet a screw stopper, but is destined to become a screw stopper (for example, by rolling in the case of a metal stopper).

It is also important to note that the method of the invention can be implemented by using a dispensing device for the stopper-skirt combinations which is of the type currently already used for known capsules, and which can be used on nearly all existing automatic filling and closing lines without these latter being penalized in terms of their production capacity, as instead happens in the case of the known method in which the screw stopper and the capsule are applied in two successive steps.

If the stopper is of metal, it is conveniently initially without the thread, the aforesaid step of the method consisting of applying the stopper-skirt combination to the mouth of the relative container necessarily comprising in this case rolling the stopper to form on its lateral wall a thread matching the external thread of the container mouth.

If however the stopper is of plastic material and already presents the internal thread, the step consisting of applying the stopper-skirt combination to the mouth of the relative container comprises screwing the stopper onto the container mouth.

The foil used to form said skirt can be in the form of substantially trapezoidal individual pieces, or can already be in the form of individual tubular elements. If the foil is of heat-shrinkable plastic material, in the first case (substantially trapezoidal pieces) an individual piece is used to form (in the conventional manner used to form known capsules) a tubular element by joining together in conventional manner the opposing edges of the piece. When the tubular element has been obtained or is already available (as in the second case), this latter is joined to the relative stopper (to form a stopper-skirt combination) by partial heart-shrinkage and/or by gluing.

If the foil used is of metal (for example of aluminium but could also be a polylaminate), in the case both of the metal stopper and of the plastic stopper the stopper and skirt can be joined together for example by gluing, whereas the subsequent rigidity between the skirt and the container can be achieved by rolling.

It should again be noted that the screw stopper is conveniently of the ring-less type (the ring no longer being essential), the elimination of the ring hence eliminating the aforesaid drawbacks due to the presence of the ring. It must however be understood that there is nothing to prevent the method of the invention using a stopper provided with a ring, if required.

According to a preferred embodiment of the method of the present invention, the foil used to form the skirt (and consequently the capsule) presents means which, when the closure and security device has been applied to the relative container, enable the relative capsule to be torn as a result of or prior to the unscrewing of the screw stopper.

It should be noted that the aforesaid means which enable the capsule to be torn can be easily obtained by using a starting foil having a thickness such as to enable the capsule to be torn as the screw stopper is unscrewed.

The second aforesaid object is attained by virtue of the closure and security device of the present invention for containers with a threaded circular mouth, said device comprising a screw stopper (without ring) and a capsule rigid both with the screw stopper and with the adjacent part of the outer surface of the container, the capsule comprising means which enable it to be torn as a result of or prior to the unscrewing of the screw stopper.

Preferably the means which enable the added capsule to be torn as a result of unscrewing the screw stopper comprise one or more capsule weakening lines or zones provided in a suitable position, along which capsule tearing takes place. By way of example, weakening lines or zones are obtained by providing a series of through perforations fairly close together in the capsule in positions in which the unscrewing of the stopper causes capsule tearing; or by providing lines or zones in which the capsule material has been thinned to achieve the same effect.

If the capsule is provided with means to tear the capsule before unscrewing the screw stopper, these means can consist of a conventional pull tab.

The invention will be more easily understood from the ensuing description of some embodiments thereof. In this description reference is made to the accompanying drawings, in which:

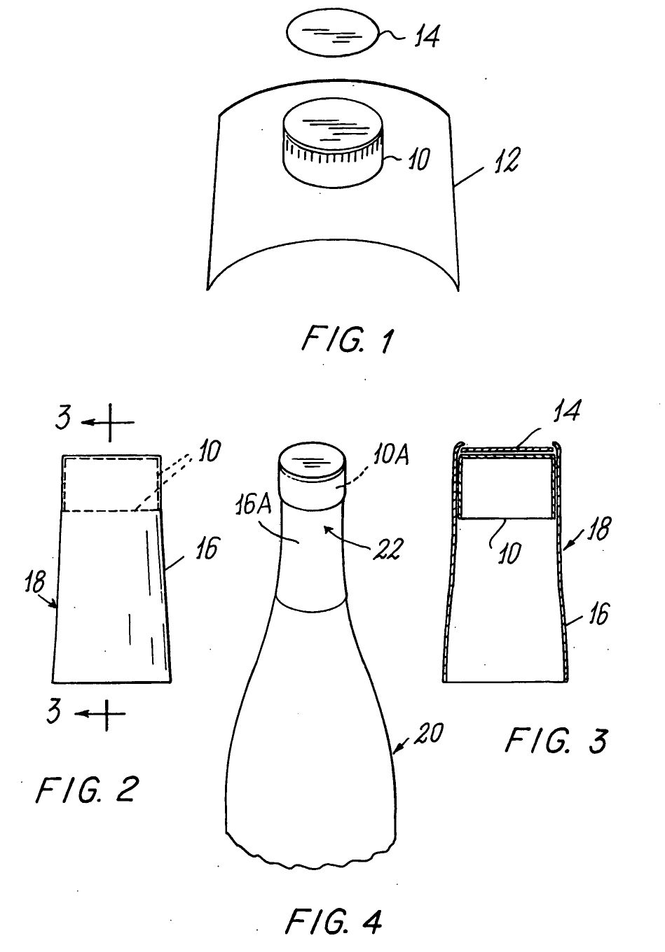

FIG. 1 is a perspective view showing the starting elements from which a device of the invention is obtained;

FIG. 2 is a side elevation of the stopper-skirt combination (constituting in practice an intermediate product) obtained with the elements shown in FIG. 1;

FIG. 3 is a section therethrough on the line 3-3 of FIG. 2;

FIG. 4 is a partial perspective view—of reduced dimensions compared with the preceding figures—of a bottle of the type provided with an externally threaded mouth, said stopper-skirt combination having been applied to the bottle and made rigid therewith to obtain the stopper-capsule, the capsule tearing means not being shown in said stopper-capsule (or in the stopper-skirt combination of the preceding figures) in order not to create confusion (although they are in effect present, and for greater clarity are shown separately in FIGS. 8-11);

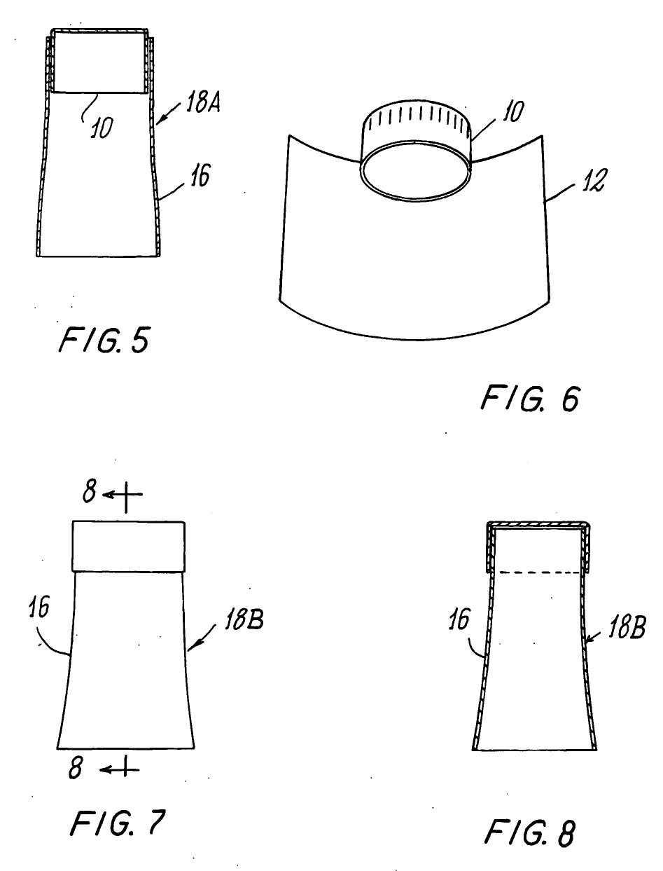

FIG. 5 is a figure similar to FIG. 3, but with the difference that the stopper-skirt combination is without the headpiece;

FIG. 6 is a perspective view showing the starting elements from which another embodiment of the stopper-capsule of the invention is obtained;

FIG. 7 is a side elevation of the stopper-skirt combination obtained with the elements shown in FIG. 6;

FIG. 8 is a section therethrough on the line 8-8 of FIG. 7;

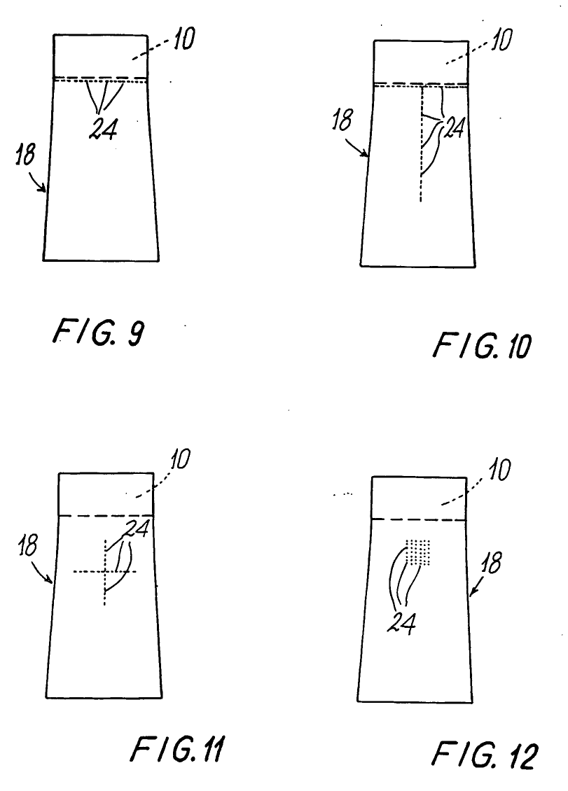

FIGS. 9-12 are a side view of a stopper-capsule shown isolated from the relative container and obtained from the stopper-skirt combination of FIG. 2, these figures showing various types of means for tearing the capsule as a result of unscrewing the stopper.

FIG. 1 shows a metal stopper (for example of aluminium) in the form of an inverted cup, of the type without a ring and as yet without the thread. The figure also shows a substantially trapezoidal piece 12 obtained from a foil of conventional heat-shrinkable plastic material which (as indicated by the curved configuration of the foil piece 12) is wound into a tube and bonded or glued in usual manner along its two opposing vertical edges to obtain a tubular element. As already stated, instead of starting from the substantially trapezoidal foil piece 12, a tubular element of heat-shrinkable plastic material, obtained for example by extrusion, can be used directly. In whichever manner the tubular element is obtained, it has a diameter slightly greater than the diameter of the stopper 10, so that this latter can be inserted without difficulty into the top part of the tubular element.

In the specific example of FIGS. 1-3, there is also present a so-called “headpiece” 14 (which can however also be dispensed with), i.e. a metal or plastic disc also used in conventional capsules to close them upperly, and which in the present case is intended to be disposed on top of the stopper 10, the upper edge of the tubular element having an elevation slightly greater than that of the headpiece 14.

By partially heat-shrinking the upper part of said tubular element, this latter shrinks against the lateral surface of the stopper 10, so that the stopper 10 is now provided with a skirt 16 (forming the said stopper-skirt combination, shown in FIGS. 2 and 3, and constituting a sort of intermediate product), the skirt consequently assuming a slightly flared shape. This partial shrinkage also enables the headpiece 14 to be fixed in position. In this manner the situation shown in FIGS. 2 and 3 is obtained. It should be noted that in FIG. 3, for reasons of clarity, the thicknesses of the various parts are shown slightly increased, these parts being shown separated from each other (in contrast to reality), to better distinguish between them. In this manner the said stopper-skirt combination, indicated overall by 18, is obtained.

The combination 18 is applied to the threaded mouth of a bottle 20 (FIG. 4) by conventional automatic machines. The stopper-skirt combination 18 is then made rigid with the bottle 20, again using conventional automatic machines, by a first step consisting of a rolling operation by which in the lateral surface of the metal stopper 18 a thread (not shown for simplicity) matching the external thread of the mouth of the bottle 20 is formed, and a second step consisting of completing the heat shrinkage of the skirt 16, which hence also adheres tightly to the relative part of the bottle 20, to essentially obtain the stopper-capsule 22 shown in FIG. 4.

As already stated and as will be better understood from the aforegoing description relating to FIGS. 1-4, the use of the method of the present invention does not penalize the production of a conventional bottling line, which instead is penalized if using the known method by which the screw stopper is firstly applied followed by application of the capsule.

It should also be noted that the method of the present invention is independent of whether the stopper is of the type with or without a ring, although in effect it is preferable to use a simple screw stopper (without a ring) to avoid the problems (initially described) presented by screw stoppers with a ring.

It has already been stated that by means of the method of the present invention a stopper-capsule can be formed comprising means which cause tearing of the capsule as a result of unscrewing the screw stopper. As already stated, this result can be obtained very simply by choosing a starting foil piece 12 or tubular element of small thickness, so that the application of a normal stopper unscrewing force results in tearing of the capsule (in this case the tearing will be random). For determined materials, or if capsule tearing is required to always take place in the same manner, it is preferable to provide capsule weakening lines or zones in the capsule (actually in the starting foil piece 12 or tubular element) along which the capsule tears on unscrewing the stopper. These weakening lines or zones can be obtained for example by providing lines or zones in the capsule (conveniently in the skirt) which have a thickness less than the remaining parts, so that tearing takes place in correspondence with these; alternatively the capsule can be provided with a series of close-together perforations 24 disposed along particular lines or in particular zones, as shown in FIGS. 9-12.

As already stated the headpiece 14 can be dispensed with.

In that case the upper edge of the skirt can be of the same elevation as the top of the stopper or even lower (provided the skirt embraces a sufficient part of the lateral surface of the stopper), as shown for the stopper-skirt combination 18A of FIG. 5.

The starting elements shown in FIG. 6 are again the foil piece 12 (or alternatively the tubular element) of heat-shrinkable plastic material and the metal stopper 10 (these being shown in the figure from a viewpoint different from that of FIG. 1), the headpiece 14 lacking in this specific case. However the true difference lies in the manner in which the stopper-skirt combination (indicated in FIGS. 7 and 8 by 18B) is formed. The tubular element is in effect given a determined conicity. In addition the upper end of the tubular element is inserted into the interior of the stopper 10, as shown in FIGS. 7 and 8, and is made rigid with the stopper 10 by gluing, to hence provide the stopper with a skirt 16 and form the stopper-skirt combination 18B. The remainder of the method is identical to that previously described with reference to FIGS. 1-4. The stopper-capsule obtained can again present capsule tearing means, and in particular those (24) illustrated with reference to FIGS. 9-12.

It should be noted that instead of being of metal, the stopper 10 can be of a conventional plastic material used to form screw stoppers, in which the stopper is obtained by injection moulding and already presents the internal thread. In this case the step by which the stopper-skirt combination is applied to the relative bottle no longer includes rolling, which is replaced by simple screwing of the stopper (together with the relative skirt) onto the bottle mouth. The other steps of the method are the same as those already described with reference to FIGS. 1-4.

It has been stated that the starting foil piece 12 or tubular element can be in the form of metal foil, including a polylaminate. In this case the skirt is made to adhere firstly to the stopper alone (to obtain the stopper-skirt combination) by gluing, and then to the bottle by rolling. If the stopper is also of metal, rolling must firstly be applied to form the stopper thread, whereas if the stopper is of plastic material (and hence is already provided with the thread), the stopper (to which the metal skirt has already been applied by rolling) has to be screwed onto the bottle mouth.

Writings, trademarks or various decorations can be reproduced on the starting foil piece or tubular element by the usual methods used for conventional capsules. The possible headpiece and stopper can also be decorated and/or carry writings and/or trademarks.

It should be further noted that if a stopper-skirt combination with the stopper external to the skirt is used (FIGS. 2 and 3), the distribution of the stopper-skirt combinations within the automatic filling and closure lines is facilitated. In this respect a series of stopper-skirt combinations inserted one into another can be fed to the relative machines of these lines, as the free edge of the stopper (which lies inside the skirt) acts as a spacer means to correctly space apart the various stopper-skirt combinations, without having to provide in the skirt suitable annular grooves or projections acting as spacers, as happens in the case of conventional capsules.

It has also been seen that the fact of having a stopper-skirt combination in which the skirt can be made rigid with the stopper, which itself can be rigidly fixed to the container, prevents any slight raising of the capsule during retraction (a drawback which can arise in the case of conventional capsules), to prejudice the final appearance of the closure. Consequently the known low-cost tunnels can be used in a bottling line instead of the bulky and costly headstock machines.

It should be noted that even if the stopper-capsule device of the invention comprises a metal stopper and plastic capsule, no metal part remains attached to the container once opened, as instead happens in the case of containers closed by the known metal screw stopper with ring (especially in its variant known by the name STELVIN). In that case the metal ring remains attached to the container, this constituting a problem for recycling glass containers. In this respect, in furnaces used to melt the salvaged glass the contained metals deposit on the bottom of the furnace, making continuous maintenance necessary. This does not happen if the stopper-capsule device of the present invention is used in the metal stopper version, provided the capsule is of plastic (for example PVC). In effect, once the container has been opened, at most only plastic foil parts remain adhering to the container, to burn off in the furnace without leaving deposits and without contamination.

1-42. (canceled)

43. A method for forming a closure and security device (22) comprising a screw stopper (10A) and a security capsule (16A) and applying it to containers provided with an externally threaded circular mouth, the method comprising the following steps:
connecting to a metal stopper, destined to become a screw stopper once applied to the container (20), a capsule-forming foil (12) in such a manner as to provide the stopper (10) with a skirt (16) projecting by a determined portion from the free edge of the stopper (10), to obtain a stopper-skirt combination (18; 18A; 18B);
applying the stopper-skirt combination (18; 18A; 18B) to the mouth of the relative container (20);
making the skirt (16) rigid with the container (20) by known capsule techniques, depending on the type of foil used, to obtain a stopper-capsule (22);
characterized in that, before making the skirt (16) rigid with the container (20), the stopper (10) is rolled to form on its lateral wall a thread matching the external thread on the mouth of the container (20).

44. A method as claimed in claim 43, wherein the foil used to form the skirt is in the form of substantially trapezoidal foil pieces (12).

45. A method as claimed in claim 43, wherein the foil used to form the skirt (16) is in the form of tubular elements.

46. A method as claimed in claim 43, wherein the foil used to form the skirt (16) is metallic.

47. A method as claimed in claim 43, wherein the foil used to form the skirt (16) is of a heat-shrinkable plastic material.

48. A method as claimed in claim 46, wherein the skirt (16) and stopper (10) are made mutually rigid by gluing.

49. A method as claimed in claim 47, wherein the skirt (16) and stopper (10) are made mutually rigid by heat-shrinkage and/or gluing.

50. A method as claimed in claim 47, wherein the step consisting of making the skirt (16) rigid with the container (20) comprises heating the skirt (16) to cause it to heat-shrink.

51. A method as claimed in claim 46, wherein the step consisting of making the skirt rigid with the container comprises rolling.

52. A method as claimed in claim 46, wherein the foil (12) is of aluminium or tin.

53. A method as claimed in claim 46, wherein the foil (12) is a polylaminate.

54. A method as claimed in claim 43, wherein the foil (12) used presents means (24) which, with the closure and security device (22) applied to the container (20), enable the relative capsule (16A) to be torn as a result of or prior to the unscrewing of the screw stopper (10A).

55. A method as claimed in claim 54, wherein the means which enable the capsule (16A) to be torn consist of using a foil (12) of a thickness which enables the capsule (16A) to tear when the screw stopper (10A) is unscrewed.

56. A method as claimed in claim 54, wherein the means which enable the capsule (16A) to be torn consist of using a foil (12) presenting one or more weakening lines or zones (24), in correspondence with which tearing of the capsule (16A) takes place when the stopper (10A) is unscrewed.
